(19) United States
(12) Patent Application Publication
(10) Pub. No.: US 2024/0385679 A1
(43) Pub. Date: Nov. 21, 2024

(54) COMPUTER-IMPLEMENTED METHOD FOR DETERMINING AT LEAST ONE STANDBY CONSUMPTION OF AT LEAST ONE ELECTRICAL DEVICE OF A TECHNICAL SYSTEM

(71) Applicant: Siemens Aktiengesellschaft, Munchen (DE)

(72) Inventors: Stefan Rothbauer, Augsburg (DE); Jürgen Salecker, München (DE)

(21) Appl. No.: 18/663,290

(22) Filed: May 14, 2024

(30) Foreign Application Priority Data
May 16, 2023 (DE) 10 2023 204 566.4

(51) Int. Cl. G06F 1/3296; G06F 1/3206

(52) U.S. Cl. CPC G06F 1/3296; G06F 1/3206

(57) ABSTRACT

A method for determining at least one standby consumption of at least one electrical device of a technical system is provided, including: determining at least one time series by at least one current converter, recognizing at least one pattern in the at least one time series based on a plurality of known reference patterns by a computing unit, assigning the at least one pattern to the at least one electrical device based on the at least one recognized pattern by the computing unit, determining an electrical energy for the at least one electrical device as the at least one standby consumption based on the at least one time series by the computing unit, and providing the at least one standby consumption of the at least one electrical device. A technical system and a corresponding computer program product are also provided.

### CROSS-REFERENCE TO RELATED APPLICATIONS

This application claims priority to DE Application No. 10 2023 204 566.4, having a filing date of May 16, 2023, the entire contents of which are hereby incorporated by reference.

### FIELD OF TECHNOLOGY

The following relates to a computer-implemented method for determining at least one standby consumption of at least one electrical device of a technical system. Furthermore, the following is directed to a corresponding technical system and a computer program product.

### BACKGROUND

Building automation in the field of building technologies is becoming increasingly important. In this context, the term smart building refers to both technical methods and systems for automating and networking buildings and appropriately equipped buildings.

Intelligent building control plays a central role in smart buildings. Intelligent building control can also be designed as an integrated building management system. Intelligent building control centrally controls a wide range of services, such as lighting, fire protection, access control and room occupancy. Each service in turn consists of smart components that collect data and communicate with each other, among other things.

One challenge is to exploit the energy-saving and performance potentials of smart buildings and thus optimize energy consumption and to make building operation efficient and sustainable.

Normally, electrical devices consume power in the standby mode. It is therefore desirable to identify these electrical devices and determine their standby consumption in order to be able to exploit the energy-saving potential. However, accurate and cost-effective determination of the standby consumption is still also a major challenge.

According to the conventional art, such a determination requires a large amount of time and measurement technology. Furthermore, it is currently not possible to prevent the normal use of the devices from significantly distorting the measured values for the standby consumption. Furthermore, the local installations of the electrical devices often prevent measurement devices from being able to be connected there at all. Furthermore, the manufacturer's data on standby consumption are usually insufficient.

Typically, individual measurement devices are used according to the conventional art. The disadvantage is that the individual measurement devices not only record the standby consumption (standby mode), but also the energy consumption during normal use (operating mode). As a result, the approach from the conventional art cannot accurately record the standby consumption and the associated standby costs.

Embodiments of the present invention therefore has the object of providing a computer-implemented method for determining at least one standby consumption of at least one electrical device of a technical system, which method is more efficient and reliable.

### SUMMARY

An aspect relates to a computer-implemented method for determining at least one standby consumption of at least one electrical device of a technical system, having the steps of:
a. determining at least one time series by at least one current converter; wherein
   the at least one time series has a plurality of chronologically ordered current values in a predetermined measurement period; wherein
   the at least one current converter is configured to measure electrical currents; wherein the predetermined measurement period is a period outside use of the at least one electrical device;
b. recognizing at least one pattern in the at least one time series based on a plurality of known reference patterns by a computing unit;
c. assigning the at least one pattern to the at least one electrical device based on the at least one recognized pattern by the computing unit;
d. determining an electrical energy for the at least one electrical device as the at least one standby consumption based on the at least one time series by the computing unit; and
e. providing the at least one standby consumption of the at least one electrical device.

Accordingly, embodiments of the invention are directed to a computer-implemented method for determining at least one standby consumption of at least one electrical device of a technical system. In the standby mode, the electrical device consumes power. The electrical device is part of a technical system and can also be referred to as an electrical apparatus. The technical system can be designed as a technical plant, such as an industrial plant or a production plant. Alternatively, the technical system can also be located in the field of building technologies and be designed as a smart building or other building.

In a first method step, the current converter determines one or more time series. A time series comprises chronologically ordered current values which are in a predetermined measurement period. This also results in a current value curve. The predetermined measurement period is outside the use of the electrical device. This ensures that the electrical device is connected to a power line but is not actively used by users or other technical systems. For example, many electrical devices switch to a standby mode, wherein they can perform their primary function quickly when requested, thus enabling them to be activated without long waiting times.

In a second method step, pattern recognition takes place. Reference patterns are used for this purpose. In this method step, the computing unit recognizes one or more patterns in the one or more time series using the reference patterns. The reference patterns are known patterns that have accordingly already been recognized. These reference patterns can be recognized in other words.

In a further method step, the computing unit assigns the recognized patterns to the associated electrical devices. The assignment can be done by a database and/or system knowledge.

In addition, or alternatively, the assignment can also be verified and confirmed by a user, for example by a user interface.

Furthermore, the electrical energy for the electrical device is determined and provided as the standby consumption in a final method step.

Embodiments of the present invention thus ensure that standby consumption of the electrical devices of the technical system can be determined reliably and efficiently. This enables energy-saving potentials to be exploited. The technical system, such as the smart building, can thus be optimized in terms of the energy consumption and can be operated in an energy-saving manner without disturbing normal operation.

The input data can be received via one or more input interfaces. In addition, the output data, such as the standby consumption, can also be sent via one or more output interfaces. The interfaces can be designed as serial or parallel interfaces. The interfaces ensure efficient and smooth data transmission between computing units. Data can be exchanged bidirectionally without data congestion.

In one configuration, the at least one current converter is designed as a CT (current) transformer.

In a further configuration, the at least one current converter is arranged on at least one main line of the technical system. Accordingly, the current converters are attached directly to the main lines of the technical system for current measurement. If multiple main lines are required in a technical system, multiple CT transformers are also attached. For example, one CT transformer from a plurality of CT transformers is attached in each case to the respective main line. Typically, a building, such as a smart building, has a 3-phase electrical system. In this case, a CT transformer is consequently attached to each of the three phases (L1, L2, L3).

In a further configuration, the predetermined measurement period is a period at night; the predetermined measurement period is between 1 o'clock and 3 o'clock. Accordingly, the electrical devices are usually in the standby mode at night in buildings such as smart buildings. Therefore, the measurement period at night has proved to be advantageous in order to exclude use and to ensure normal operation of the electrical devices during the day without any disturbance. The measurement period can be selected and defined flexibly depending on the electrical devices, the technical system, the user requirements and/or other conditions.

In a further configuration, the pattern recognition in step b. is an algorithmic pattern recognition for time series. Accordingly, the pattern recognition is automatically performed by an algorithm that determines statistical characteristic values for this purpose.

In a further configuration, the electrical energy is the integral of the power for the predetermined measurement period in VA. The power is the product of the current value and the voltage value. For example, the current is measured continuously every 50 ms and the voltage value is assumed to be constant at 230 V, which is an approximation. This results in an estimate of the power in VA. For a more accurate power measurement, it is possible to use the true RMS method which measures the current and voltage values every 100 μs.

Accordingly, the electrical energy is determined from the current values of the one or more time series, wherein the current values are considered in the predetermined measurement period. In this configuration, the electrical energy is provided as an integral in VA.

In a further configuration, the computer-implemented method further comprises performing an extrapolation taking into account the at least one standby consumption of the at least one electrical device, determining a standby consumption for a year. Accordingly, the determined and provided electrical energy is used as the standby consumption for one or more extrapolations. The daily and/or monthly standby consumption can be determined in an extrapolation. Alternatively, or additionally, the annual standby consumption is determined in this configuration. The annual standby consumption can indicate how much electrical energy is consumed by the electrical device in a year. These extrapolations can be used to identify the standby consumption of the electrical devices and thus, for example, have the possibility of replacing or switching off the identified devices (if possible) by suitable measures, if sensible, or of contacting the device manufacturer on account of incorrect information in the sales brochure, and thus saving energy.

In a further configuration, the computer-implemented method further comprises
providing at least one message in the form of a text message and/or voice message when the at least one standby consumption changes and/or initiating at least one remedial action when the at least one standby consumption changes; wherein
   the change is detected by comparing the at least one standby consumption with at least one reference standby consumption and
   by determining a deviation of the at least one standby consumption from the at least one reference standby consumption.

In a further configuration, the at least one remedial action is maintenance of the at least one electrical device, a test of the at least one electrical device and/or a replacement of the at least one electrical device.

Accordingly, the determined standby consumption of the electrical device is compared with at least one reference standby consumption in order to determine a deviation. The deviation indicates whether the standby consumption changes, for example increases or decreases. The reference consumption is a known consumption of the electrical device, a consumption that is usually expected with the assigned electrical device.

The standby consumption may exceed the reference standby consumption. The standby consumption of the electrical device thus increases compared to the reference standby consumption.

The standby consumption may be less than the reference standby consumption. The standby consumption of the electrical device thus decreases compared to the reference standby consumption.

In the event of a change, a message is provided in the form of a text message and/or voice message. The message can be displayed to a user on a display unit or transmitted to a computing unit for review or analysis. Alternatively, or additionally, a remedial action is triggered. For example, the electrical device can be repaired or replaced after a test. The advantage is that downtimes and bearing damage of the affected electrical devices and also of the underlying technical system are significantly reduced.

In a further configuration, the computer-implemented method further comprises
providing information relating to the at least one electrical device and/or the at least one time series as additional output data;
outputting the at least one standby consumption of the at least one electrical device, information relating to the at least one electrical device and/or the at least one time series on a display unit;
storing the at least one standby consumption of the at least one electrical device, information relating to the at least one electrical device and/or the at least one time series in a storage unit; and/or
transmitting the at least one standby consumption of the at least one electrical device, information relating to the at least one electrical device and/or the at least one time series to a computing unit.

Accordingly, one or more method steps can be carried out after providing the electrical energy as an output value in the form of the standby consumption of the method according to embodiments of the invention. This standby consumption can be supplemented with any input and/or output data. In embodiments, the method steps can be performed simultaneously, sequentially or in stages.

The input data and/or output data can be transferred to any computing unit, such as a display, processing, or storage unit. The standby consumption can be stored in a storage unit. The storage unit can be a volatile or non-volatile storage unit, for example a database or cloud. The storage unit enables reliable and fast data backup. Furthermore, the standby consumption itself or in the form of a corresponding message or notification can be transmitted to a terminal and/or displayed to a user by a display unit. The receiving computing unit can also initiate further appropriate measures after receipt.

The output data can be used as training data for machine learning, such as a neural network. A neural network can be trained using the recorded current data (or the calculated power “VA”) and the detected standby devices. The neural network can identify not only the current standby devices, but also new devices.

Embodiments of the invention also relate to a technical system for carrying out the above method.

Embodiments of the invention further relate to a computer program product (non-transitory computer readable storage medium having instructions, which when executed by a processor, perform actions) comprising a computer program that has means for carrying out the method described above when the computer program is executed on a program-controlled device.

A computer program product, such as a computer program means, for example, may be provided or delivered, for example, as a storage medium such as a memory card, a USB stick, a CD-ROM, a DVD, for example, or else in the form of a file downloadable from a server in a network. This may take place, for example, in a wireless communication network through the transmission of an appropriate file comprising the computer program product or the computer program means. In embodiments, a control device such as an industry control PC or a programmable logic controller, in short PLC, or a microprocessor for a smartcard or the like can be considered as a program-controlled device.

### BRIEF DESCRIPTION

Some of the embodiments will be described in detail, with reference to the following figures, wherein like designations denote like members, wherein:

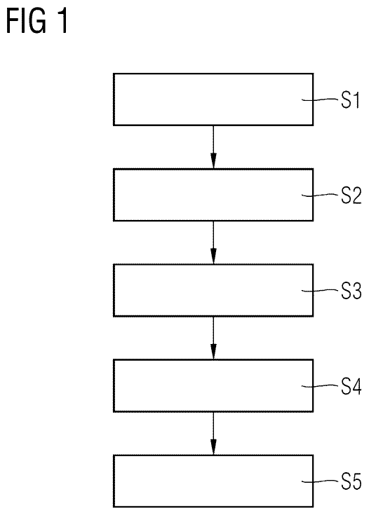

FIG. 1 shows a schematic flowchart of the method according to embodiments of the invention;

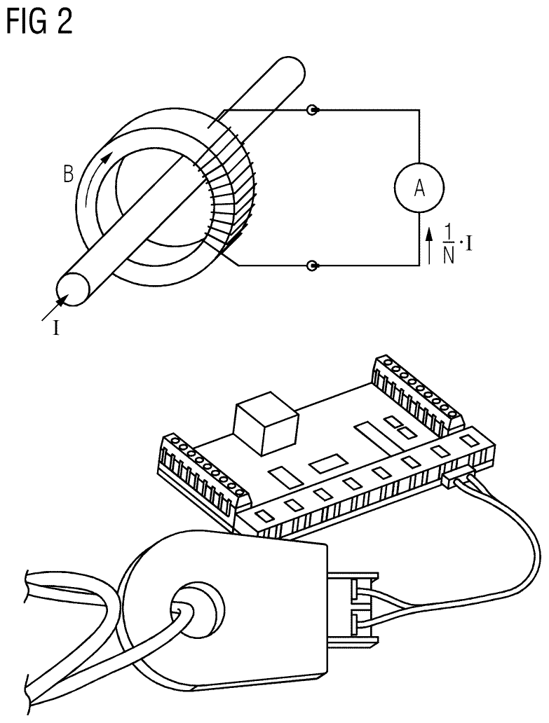

FIG. 2 shows a CT current converter according to the conventional art;

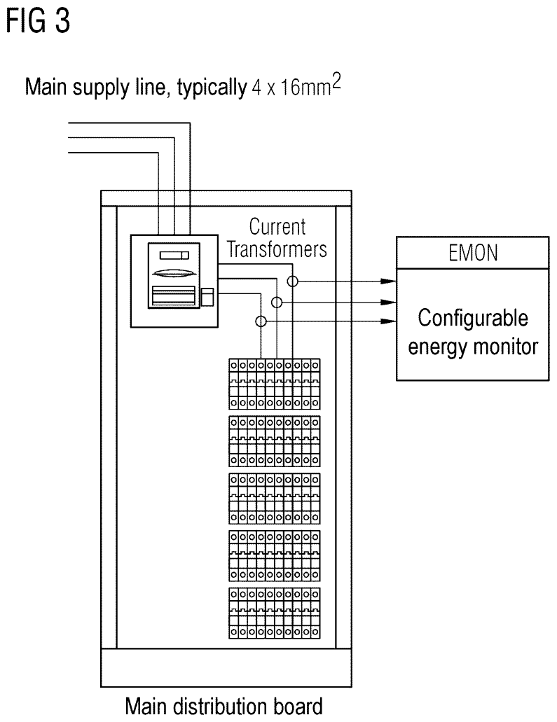

FIG. 3 shows a schematic view of the technical system with CT current converters according to an embodiment of the invention;

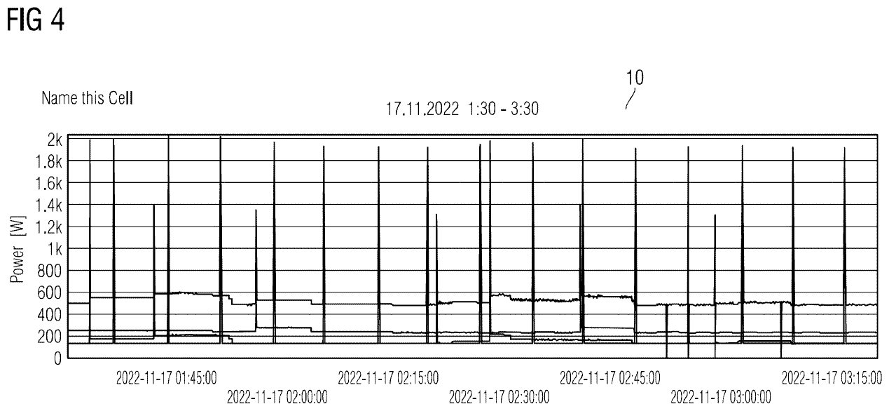

FIG. 4 shows recorded chronologically ordered current values in the measurement period between 1:30 h and 3:30 h at night according to an embodiment of the invention;

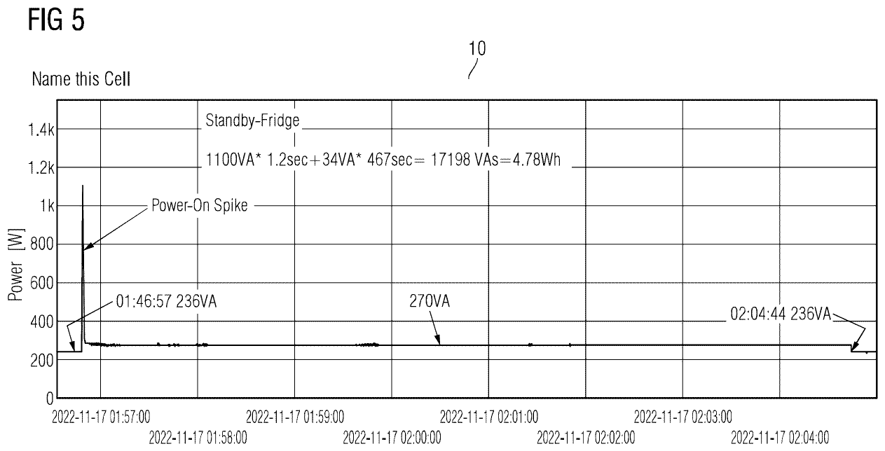

FIG. 5 shows a detailed view of the chronologically ordered current values according to FIG. 4 according to an embodiment of the invention; and

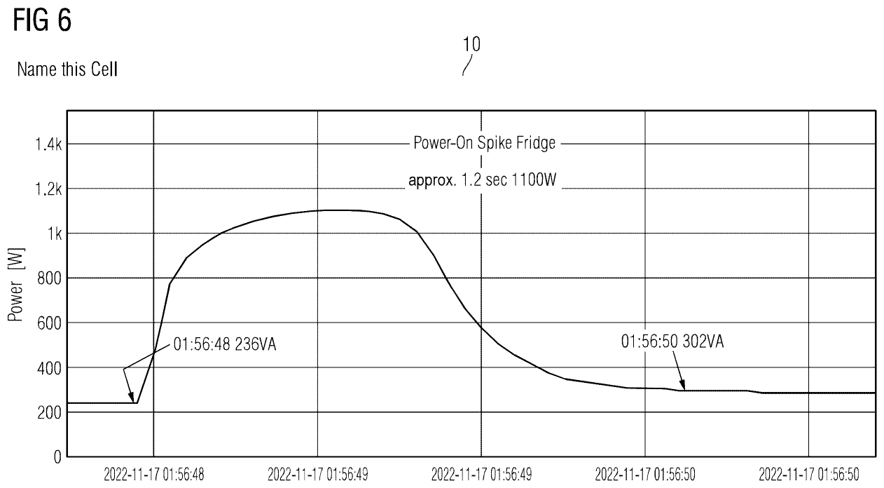

FIG. 6 shows a detailed view of the switch-on peak of the chronologically ordered current values according to FIG. 5 according to an embodiment of the invention.

### DETAILED DESCRIPTION

Embodiments of the present invention will be described below in relation to the figures.

FIG. 1 schematically illustrates a flowchart of the method according to embodiments of the invention having method steps S1 to S5.

In a first method step, the current converter determines the time series S1. In a second method step, the computing unit recognizes a pattern in the time series using the reference patterns S2. Accordingly, in other words, pattern recognition takes place. In a further method step, the computing unit assigns the recognized pattern to the electrical device S3. Accordingly, in other words, the electrical device is assigned. In a further method step, the computing unit determines an electrical energy for the electrical device as the standby consumption S4. In a final method step, the at least one standby consumption is provided S5.

FIG. 2 shows a CT current converter according to the conventional art with the electrotechnical principle (on the left) and with recording electronics (on the right).

FIG. 3 shows a schematic view of the technical system with CT current converters according to an embodiment of the invention. The currents are measured by the foldable CT transformers. In an embodiment, three CT transformers are installed on the three main lines of the three main distribution boards of the technical system. The technical system can therefore be designed as a building with electrical devices. One of the electrical devices may be a refrigerator. The advantage is that no line needs to be disconnected.

The CT current converters according to FIG. 2 and FIG. 3 can provide data in different resolutions: once processed data in the form of a smoothed version and/or the raw data. The processed data can be displayed directly on an APP. The raw data can be used for further analyses. For example, they can be stored in external databases for this purpose. Depending on the further type of use and the associated requirements for access time or computing power, a database in the cloud (Influx DB, Mongo DB, etc.) or a database on a local NAS is selected for this purpose.

In contrast to the conventional art, it is not necessary to perform true apparent, reactive and active power measurements (true RMS). Recording only the current values with a resolution of 200 ms and 50 ms during night time (1:00 to 3:00) has proved to be particularly advantageous and sufficient.

The current measurements by the CT current converters are carried out according to an embodiment with a sample rate of 50 ms always at night between 1:00 and 3:00 S1. This measurement period has proved to be beneficial in preventing disturbances from device usage. Alternatively, it can also be ensured otherwise that no user-induced device usage exists during the measurement period in question.

The raw data are searched for recurring patterns according to an embodiment S2. The recognized patterns are parameterized with static consumption values. The pattern recognition and the relatively high sample rate thus make it possible to detect individual electrical devices very precisely and thus also to be able to capture them. According to an embodiment, the pattern recognition is an automated, for example algorithmic pattern recognition for time series. For example, the “motif discovery” algorithm can be used using matrix profiles. The recognized patterns are assigned to the electrical devices S3.

In the event of significant deviations or the regular occurrence of one or more new patterns, a message can be output in order to enable a detailed analysis. If a new pattern occurs, the new pattern can also be assigned to an electrical device and thus integrated.

This analysis can be repeated regularly, for example daily or weekly. A potential temporal evolution of the patterns of individual electrical devices is thus detected. This makes the ability to assign detected events in the measurement data to the electrical devices more precise. For example, an evolution is the continuous change in the standby consumption behavior at a longer interval of time.

If a significant change in the consumption pattern is detected for one or more consumers over time, a message can be issued.

After the individual current values have been recorded, the integral in VA of the current value curve for the time from 1:00 to 3:00 is calculated and provided for each detected electrical device according to an embodiment S4, S5. This separates the power consumption of the electrical devices from any simultaneous standby consumption processes.

The following calculations allow the standby consumption of the detected electrical devices to be extrapolated:

$$SV = Standby consumption in the year [ kVAh ]$$

$$n = Number of complete switch - on cycles of an electrical device within a measurement period$$

$$TMess = measurement time [ h ]$$

$$XVa ( t ) = Power consumption of an electrical device in a switch - on cycle [ VA ] at the time t$$

$$t 0 , t 1 = start time , end time of a representative consumption cycle$$

$$SV = 365 * T\_Mess / ( 24 h ) * n * \int \_ ( t\_ 0 ) \hat{} ( t\_ 1 )$$

$$〚 X\_va ( t ) dt 〛$$

For example, the standby consumption is measured for 2 h. Usually there are overlaps (before 1:00 h and after 3:00 h). Therefore, only the measurement periods that can be uniquely identified are taken according to an embodiment. The exact measurement time of approx. 2 h can be seen as a reference point and will in reality level out between approx. 90 min and 120 min.

FIGS. 4 to 6 show real records of the standby consumption at night for a building with a refrigerator.

FIG. 4 shows recorded chronologically ordered current values in the measurement period between 1:30 h and 3:30 h at night according to an embodiment of the invention. FIG. 4 includes all cyclic standby consumption during the measurement period.

FIG. 5 shows a detailed view of the chronologically ordered current values according to FIG. 4 according to an embodiment of the invention. In FIG. 5, the standby consumption of a refrigerator as an electrical device is considered over the entire consumption time based on the data from FIG. 3.

The switch-on peak is analyzed in more detail and shown in detail in FIG. 6 in order to enable unique identification. This provides a complete picture of the standby consumption of the refrigerator.

FIG. 6 shows a detailed view of the switch-on peak of the chronologically ordered current values according to FIG. 5 according to an embodiment of the invention.

Although the present invention has been disclosed in the form of embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements.

1. A computer-implemented method for determining at least one standby consumption of at least one electrical device of a technical system, the method comprising:
having:
a. determining at least one time series by at least one current converter; wherein:
the at least one time series has a plurality of chronologically ordered current values in a predetermined measurement period;
the at least one current converter is configured to measure electrical currents;
the predetermined measurement period is a period outside use of the at least one electrical device;
b. recognizing at least one pattern in the at least one time series based on a plurality of known reference patterns by a computing unit;
c. assigning the at least one pattern to the at least one electrical device based on the at least one recognized pattern by the computing unit;
d. determining an electrical energy for the at least one electrical device as the at least one standby consumption based on the at least one time series by the computing unit; and
e. providing the at least one standby consumption of the at least one electrical device.

2. The computer-implemented method as claimed in claim 1, wherein the at least one current converter is designed as a current transformer.

3. The computer-implemented method as claimed in claim 1, wherein the at least one current converter is arranged on at least one main line of the technical system.

4. The computer-implemented method as claimed in claim 1, wherein the predetermined measurement period is a period at night.

5. The computer-implemented method as claimed in claim 1, wherein the at least one pattern recognition in step b. is an algorithmic pattern recognition for time series.

6. The computer-implemented method as claimed in claim 1, wherein the electrical energy is an integral of a power for the predetermined measurement period in VA.

7. The computer-implemented method as claimed in claim 1, further comprising:
performing an extrapolation taking into account the at least one standby consumption of the at least one electrical device, and determining a standby consumption for a year.

8. The computer-implemented method as claimed in claim 1, further comprising:
outputting at least one message in a form of a text message and/or a voice message when the at least one standby consumption changes and/or initiating at least one remedial action when the at least one standby consumption changes; wherein
the change is detected by comparing the at least one standby consumption with at least one reference standby consumption and
by determining a deviation of the at least one standby consumption from the at least one reference standby consumption.

9. The computer-implemented method as claimed in claim 7, wherein the at least one remedial action is maintenance of the at least one electrical device, a test of the at least one electrical device and/or a replacement of the at least one electrical device.

10. The computer-implemented method as claimed in claim 1, further comprising:
providing information relating to the at least one electrical device and/or the at least one time series as additional output data;
outputting the at least one standby consumption of the at least one electrical device, information relating to the at least one electrical device and/or the at least one time series on a display unit;
storing the at least one standby consumption of the at least one electrical device, information relating to the at least one electrical device and/or the at least one time series in a storage unit; and/or
transmitting the at least one standby consumption of the at least one electrical device, information relating to the at least one electrical device and/or the at least one time series to a computing unit.

11. A technical system for carrying out the method as claimed in claim 1.

12. A computer program product, comprising a computer readable hardware storage device having computer readable program code stored therein, said program code executable by a processor of a computer system to implement a method as claimed in claim 1 when the computer program is executed on a program-controlled device.

13. The computer-implemented method as claimed in claim 1, wherein the predetermined measurement period is between 1 o'clock and 3 o'clock.
